(19) United States
(12) Patent Application Publication
(10) Pub. No.: US 2006/0055282 A1
(43) Pub. Date: Mar. 16, 2006

(54) Electrostatic actuator and image pickup apparatus

(76) Inventor: Masayuki Sekimura, Chofu-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/224,232

(22) Filed: Sep. 13, 2005

(30) Foreign Application Priority Data
Sep. 16, 2004 (JP) 2004-270253

(51) Int. Cl. H02N 1/00

(52) U.S. Cl. 310/309

(57) ABSTRACT

The present invention has a movable section guided by a stator so as to be movable in a direction in which a penetrating portion penetrates the stator. A film is provided on an area of the movable section which comes into contact with the stator when the movable section moves in the penetrating direction of the penetrating portion. The provision of the film reduces the coefficient of friction between a support of the movable section and a stator frame or a driving electrode substrate. This allows the movable section to move at high speed. The present invention can provide an electrostatic actuator and an image pickup apparatus in which the movable section can move at high speed.

### CROSS-REFERENCE TO RELATED APPLICATIONS

This application is based upon and claims the benefit of priority from prior Japanese Patent Application No. 2004-270253, filed Sep. 16, 2004, the entire contents of which are incorporated herein by reference.

### BACKGROUND OF THE INVENTION

1. Field of the Invention

The present invention relates to an electrostatic actuator and an image pickup apparatus that uses the electrostatic actuator to drive a lens or lenses.

2. Description of the Related Art

In recent years, many efforts have been made to incorporate an image pickup apparatus with a zoom function or an auto focus function into mobile equipment such as a cellular phone. Such an image pickup apparatus drives a lens or lenses to adjust a focus to finally form an image on a sensor. An electrostatic actuator may be used as a driving source that drives the lens along an optical axis.

The image pickup apparatus can adjust a zoom scale factor and the focus by driving the lens or lenses. The electrostatic actuator comprises a stator and a movable section. The movable section holds the lens. The stator comprises a driving electrode substrate and a holding electrode substrate attached to an upper and lower inner walls, respectively, of a stator frame. The movable section is placed so that it can reciprocate along the axis of the lens between the paired electrode substrates while maintaining a gap of several μm between the movable section and each electrode substrate. The holding electrode substrate has a holding electrode that holds the movable section.

In the image pickup apparatus configured as described above, the movable section is electrostatically driven by using a switching circuit to supply voltages to the electrodes on the electrode substrates in the stator in a predetermined order as disclosed in Jpn. Pat. Appln. KOKAI Publication No. 2004-126009 and the corresponding U.S. patent application Ser. No. 10/672,409, filed Sep. 29, 2003, Koga et al.

With the conventional image pickup apparatus, when the movable section is driven by supplying voltages to the driving electrode substrate in a predetermined order, significant friction occurs between the movable section and the stator or the driving or holding electrode substrate. This reduces the moving speed of the movable section.

### BRIEF SUMMARY OF THE INVENTION

It is an object of the present invention to provide an electrostatic actuator and an image pickup apparatus having a movable section that can move at high speed.

According to an aspect of the present invention, there is provided an electrostatic actuator comprising:
a stator;
a first and second substrates each provided opposite the stator;
a movable section provided in the stator and guided by the stator so as to be movable in a predetermined direction between the first and second substrates;
a holding electrode provided on the first substrate, configured to attract and hold the movable section;
a first insulating layer which covers the holding electrode;
driving electrodes, provided on the second substrate at a fixed pitch in the predetermined direction, which drive the movable section;
a second insulating layer which covers the driving electrodes; and
a protect film provided on a surface area of the movable section which contacts the first and second insulating layers as the movable section moves.

According to another aspect of the present invention, there is provided an image pickup apparatus comprising:
a stator;
a first and second substrates each provided opposite the stator;
a movable section provided in the stator and guided by the stator so as to be movable in a predetermined direction between the first and second substrates;
a holding electrode provided on the first substrate, configured to attract and hold the movable section;
a first insulating layer which covers the holding electrode;
driving electrodes, provided on the second substrate at a fixed pitch in the predetermined direction, configured to drive the movable section;
a second insulating layer which covers the driving electrodes;
a protect film provided on a surface area of the movable section which contacts the first and second insulating layers as the movable section moves;
a lens provided in the movable section to form an image of a subject; and
an image pickup element which detects the image of the subject formed by the lens.

According to yet another aspect of the present invention, there is provided an electrostatic actuator comprising:
a stator;
a first and second substrates each provided opposite the stator;
a movable section provided in the stator and guided by the stator so as to be movable in a predetermined direction between the first and second substrates;
a holding electrode provided on the first substrate to attract and hold the movable section;
a first insulating layer which covers the holding electrode;
driving electrodes, provided on the second substrate at a fixed pitch in the predetermined direction, configured to drive the movable section;
a second insulating layer which covers the driving electrodes; and
a housing which maintains the stator, the first and second substrates, and the movable section in a vacuum, air-tight state.

### BRIEF DESCRIPTION OF THE SEVERAL VIEWS OF THE DRAWING

FIG. 1 is a partly cutaway perspective view schematically showing an image pickup apparatus using an electrostatic actuator according to a first embodiment of the present invention;

FIG. 2 is an exploded perspective view showing the image pickup apparatus using the electrostatic actuator shown in FIG. 1;

FIG. 3A is a plan view showing a driving electrode substrate incorporated into the electrostatic actuator shown in FIGS. 1 and 2;

FIGS. 3B and 3C are partly enlarged plan views showing the driving electrode substrate shown in FIG. 3A;

FIG. 3D is a plan view schematically showing a holding electrode substrate incorporated into the electrostatic actuator shown in FIGS. 1 and 2;

FIG. 4 is a vertical sectional view schematically showing the electrostatic actuator shown in FIGS. 1 and 2;

FIG. 5 is a perspective view schematically showing a first movable section in the electrostatic actuator shown in FIGS. 1 and 2; and

FIG. 6 is a graph showing the sliding angles of the first movable sections in Examples 1 and 2 of the electrostatic actuator shown in FIGS. 1 and 2 and in Comparative Examples 1, 2, and 3.

### DETAILED DESCRIPTION OF THE INVENTION

With reference to the drawings, description will be given of an electrostatic actuator according to embodiments of the present invention.

### First Embodiment

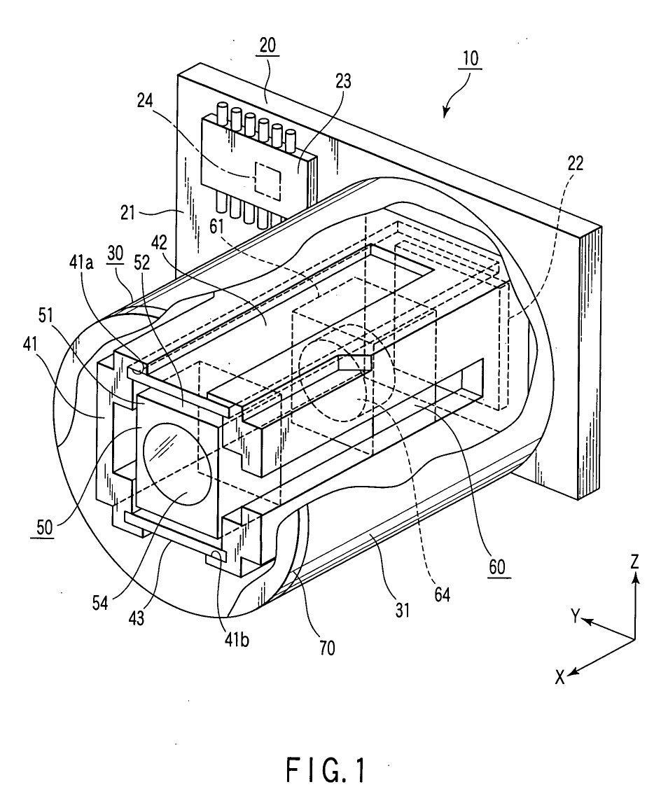

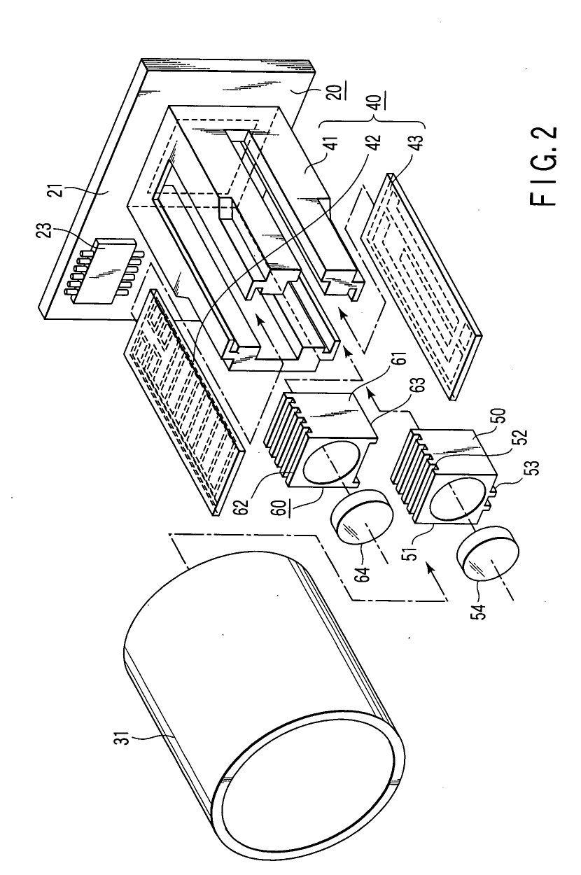

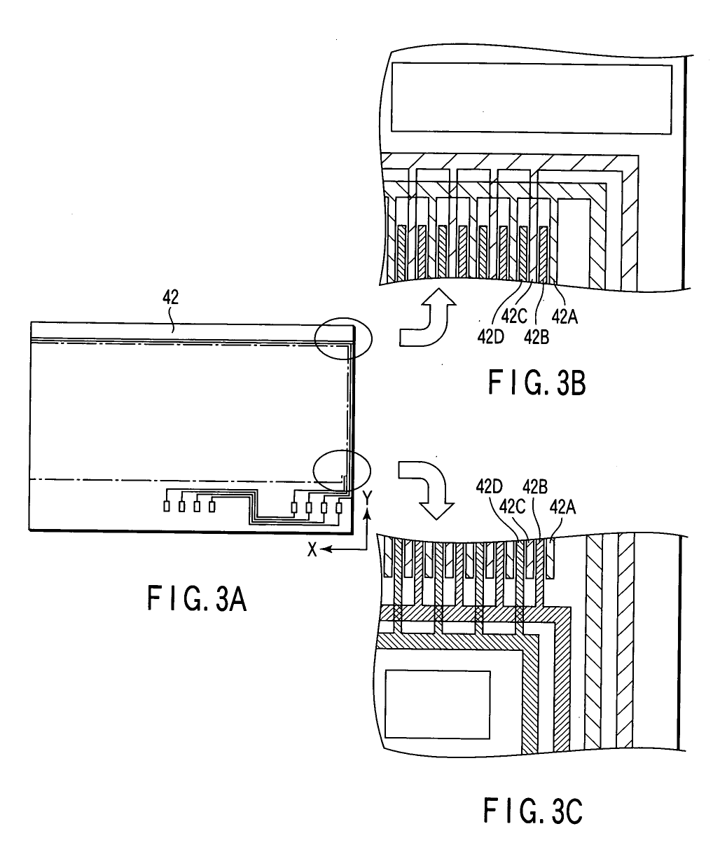

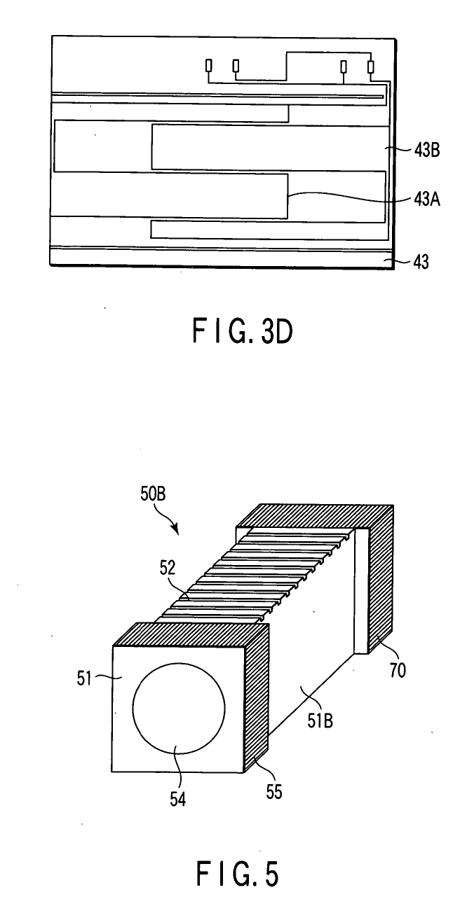

FIG. 1 is a partly cutaway perspective view schematically showing an image pickup apparatus into which an electrostatic actuator according to a first embodiment of the present invention is incorporated. FIG. 2 is an exploded perspective view of the image pickup apparatus 10 shown in FIG. 1. FIG. 3A is a plan view schematically showing a driving electrode substrate 42 in the electrostatic actuator shown in FIGS. 1 and 2. FIGS. 3B and 3C are partly enlarged plan views of the driving electrode substrate 42, shown in FIG. 3A. FIG. 3D is a plan view schematically showing a holding electrode substrate 43 in the electrostatic actuator shown in FIGS. 1 and 2. FIG. 4 is a vertical sectional view schematically showing a zoom lens unit 30 in the electrostatic actuator shown in FIGS. 1 and 2.

In FIGS. 1 to 4, arrows X, Y, Z show three orthogonal directions. In particular, arrow X corresponds to the direction in which a penetrating portion extends penetratingly through the stator frame 41 and also to the direction in which a first and second movable sections 50 and 60 move. In the description of the embodiments, arrow Z in FIG. 1 is assumed to show an upward direction. In FIG. 3A, patterns 42A to 42D are omitted because the drawing would be complicated if they were drawn as they were.

The image pickup apparatus 10 comprises the zoom lens unit 30 that transmits an image of a subject according to a zoom scale factor and an image pickup element section 20 that photographs the transmitted subject image. The zoom lens unit 30 is composed of lenses 54 and 64 described below to transmit the subject image according to a predetermined zoom ratio. The image pickup apparatus 10 comprises the image pickup element section 20 and the zoom lens unit 30. The image pickup element section 20 comprises a substrate 21, and a sensor 22 such as a CCD and a controlling electronic part 23 which are arranged on the substrate 21; the subject image is formed on the sensor, which thus detects the subject image. A driving control circuit 24 is incorporated into the electronic part 23 to drive the zoom lens unit 30, composed of an electrostatic actuator and described later.

The zoom lens unit 30 comprises a cylindrical cover 31 internally having a cavity portion extending in the direction X, a stator 40 fixed in the cavity portion, and a first movable section 50 and a second movable section 60 independently driven in the stator 40, as shown in FIGS. 1 and 2. The first and second movable sections 50 and 60 are inserted and arranged in the stator frame 41 so that they can move along the direction X of the optical axis while being separated from each other.

The stator 40 comprises a stator frame 41 that is a hollow, parallelepiped frame having a cavity portion. The stator frame 41 has an upper inner surface 41A and a lower inner surface 41B located opposite each other. The driving electrode substrate 42 is attached to the upper inner surface 41A to drive the first and second movable sections 50 and 60. Moreover, a holding electrode substrate 43 is attached to the lower inner surface 41B to hold the movable sections 50 and 60 at particular positions.

The cylindrical cover 31 or stator frame 41 is sealed and maintained in a vacuum, air-tight state by a sealing member (not shown); external dust, moisture, or the like is prevented from entering the cylindrical cover 31 or stator frame 41. For example, a glass plate 70 may be used to seal the front surface of the cylindrical cover 31. The sealed space may be maintained in a substantially vacuum state or an inert gas such as a nitrogen gas may be sealed into the space. Thus, the first and second movable sections 50 and 60 and the driving and holding electrode substrates 42 and 43 are arranged in the vacuum space or the space into which the inert gas is sealed. This prevents discharge from occurring readily between each of the first and second movable sections 50 and 60 and the driving and holding electrode substrates 42 and 43 even if a potential difference is applied to between them.

As shown in FIG. 3C, plural groups of electrodes 42A to 42D are formed on a surface of the driving electrode substrate 42, made of an insulating material; the electrodes 42A to 42D are patterned in a desired shape in order to drive the first movable section 50. In the groups of electrodes 42A to 42D, the electrodes 42A to 42D extends in a direction Y orthogonal to the moving direction X. The electrodes 42A to 42D are arranged in the moving direction X. The insulating material substrate may be, for example, a glass plate, a silicon wafer which has a thermal oxide film on its surface, or insulating substrate for printed circuit board as aramid or glass epoxy. Each of the electrodes has a width of several μm to several tens of μm. The spacing between the electrodes is several μm to several tens of μm. The electrodes are arranged at a fixed pitch. The fixed pitch includes a machining error resulting from machining.

The groups of electrodes 42A to 42D are covered with an insulating layer 80 as shown in FIG. 4. Accordingly, even if the movable section 50 or 60 is attracted to the groups of electrodes 42A to 42D, it is prevented from direct contact with and the resulting electric connection to the electrodes. A semiconductor manufacturing process is preferably utilized to form the groups of electrode 42A to 42D on the substrate 42. Accordingly, the insulating layer 80 is preferably a silicon oxide film or a silicon nitride film. The silicon oxide or nitride film can provide the insulating film 80 with a sufficient hardness and its surface with a sufficiently small coefficient of friction.

A smaller electrode pitch makes it possible to correspondingly reduce the minimum movement resolution of the first and second movable sections 50 and 60. However, an excessively small pitch requires the first and second movable sections 50 and 60 and the driving electrodes 42A to 42D to be machined very precisely. This increases costs. If, for example, the driving electrode substrate 42 is a silicon wafer having a thermal oxide film formed on its surface, the driving electrodes 42A to 42D may have a width of 12 μm, a spacing of 4 μm, and a pitch of 16 μm.

The driving electrodes 42A to 42D are connected to the driving control circuit 24 of the electronic part 23. The driving control circuit 24 inputs a control voltage signal to the driving electrodes 42A to 42D to drive them. Specifically, the voltage signal is input independently to each group of driving electrodes 42A to 42D. If the voltage signal is input to, for example, the driving electrode 42A, it is applied to the convex pattern corresponding to the driving electrodes 42A in all the groups on the driving electrode substrate 42. Here, the driving electrodes 42A correspond to a channel 1 (ch1) and the driving electrodes 42B correspond to a channel 2 (ch2). The driving electrodes 42C correspond to a channel 3 (ch3) and the driving electrodes 42D correspond to a channel 4 (ch4).

The holding electrode substrate 43 is formed of an insulating material substrate having a desired shape patterned on its surface as shown in FIG. 3D. Stripe electrodes 43A and 43B are formed in parallel over the range within which the first and second movable sections 50 and 60 move; the stripe electrode 43A corresponds to a first movable section electrode 53 on the first movable section 50, and the stripe electrode 43B corresponds to a second movable section electrode 63 (described below) on the second movable section 60. The insulating substrate may be, for example, a glass plate, or an insulating substrate for a printed circuit board such as a silicon wafer, aramid, or glass epoxy which has a thermal oxide film formed on its surface. Here, the second movable section stripe electrode 43B corresponds to a channel 5 (ch5), and the first movable section stripe electrode 43A corresponds to a channel 6 (ch6). The stripe electrodes 43A and 43B are electrically independently arranged so as to independently control the first and second movable sections 50 and 60.

As shown in FIG. 4, the stripe electrodes 43A and 43B are covered with an insulating layer 82 similarly to the electrodes 42A to 42D. Consequently, even if the movable section 50 or 60 is attracted to the stripe electrodes 43A and 43B, it is prevented from direct contact with and the resulting electric connection to the stripe electrodes. The semiconductor manufacturing process is preferably utilized to form the stripe electrode 43A and 43B on the substrate 43. Accordingly, the insulating layer 82 is preferably a silicon oxide film or a silicon nitride film. The silicon oxide or nitride film can provide the insulating film 82 with a sufficient hardness and its surface with a sufficiently small coefficient of friction.

The first movable section 50 comprises a substantially parallelepiped support 51 formed of a conductive material having a hollow portion extending in the direction X as shown in FIGS. 1 and 2. The support 51 can be formed by, for example, physically grinding or chemically etching a conductive material. Alternatively, the support 51 may be formed by injecting a conductive resin. A movable section driving electrode 52 is formed on the top surface of the support 51 in association with the electrodes 42A to 42D as shown in FIG. 4. The first movable section electrode 53 is formed on the bottom surface of the support 51 in association with the stripe electrode 43A. Moreover, a lens 54 is fixed to the hollow portion.

For example, a conductive PPS or a conducive PS resin may be used as the support 51, that is, the conductive resin constituting the first movable section 50. The conductive PPS resin is particularly preferably used as the material for the support 51 because of its electrical characteristics and moldability. Further, it is preferable to add a fluorine-based material (for example, PTEE), or potassium titanate, oil, or carbon fiber to the conductive PPS resin in order to reduce the coefficient of friction. It may be add any one of the fluorine-based material, potassium titanate, oil, and carbon fiber. However, it is also possible to add a plurality of additives, for example, PTFE and oil.

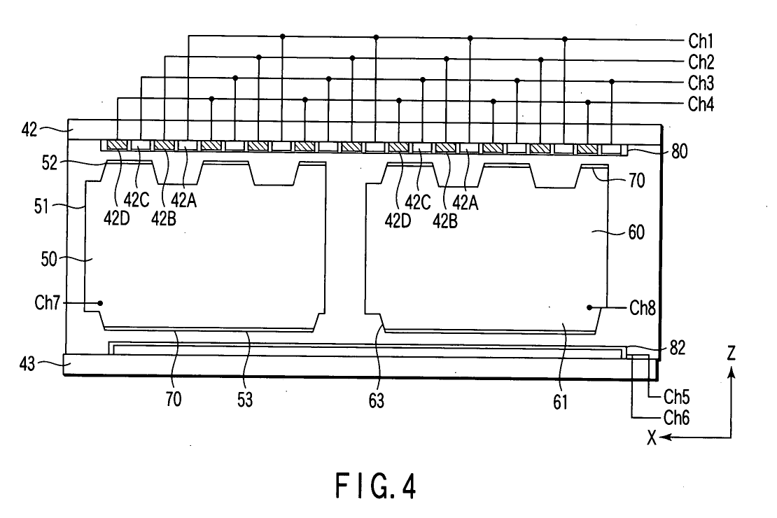

When moved between the driving electrode substrate 42 and the holding electrode substrate 43, the support 51 comes into contact with the substrates. As shown in FIGS. 4 and 5, the film 70 is provided on a contacting surface of the support 51. The film 70 is preferably made of, for example, a material containing any of deposited gold, molybdenum disulfide, a silicon oxide film, a silicon nitride film, and diamond like carbon. With gold or molybdenum disulfide, the film 70 can be formed on the surface of the support 51 using a well-known sputtering or deposition method. With a silicon nitride film, a silicon nitride film, or diamond like carbon, the film 70 can be formed using the well-known sputtering method. Alternatively, the film 70 may be produced using a well-known deposition method such as electroplating or electroless plating.

Further, another appropriate substance may be added to gold, molybdenum disulfide, a silicon oxide film, a silicon nitride film, or diamond like carbon, used as a material for the film 70. For example, hardness or wear resistance can be improved by adding a substance such as nickel, silver, indium, or cobalt to gold. The material for the film 70 can be appropriately determined according to the materials for the support 51, stator frame 41, driving electrode substrate 42, and holding electrode substrate 43, the use environment and specifications of the zoom lens unit 30, and the target lifetime.

The movable section driving electrode 52 is composed of a plurality of projection-like stripes extended orthogonally to the moving direction X of the first movable section 50. The concave and convex stripes are arranged in parallel in the direction X. The stripes correspond to the concaves and convexes formed on the surface of the electrode 52. The spacing between the stripes is set at, for example, about 32 μm. The height of each convex portion is set at about 10 μm from the surface in each concave portion. The height may be at least 10 μm and may thus be larger than 10 μm. The width of each convex of the movable section driving electrode 52 is equal to double the pitch of the driving electrodes 42A to 42D. The bottom surface of each concave of the movable section driving electrode 52 is specified to have a width equal to double the pitch of the driving electrodes 42A to 42D. If the driving electrode substrate 42 is a silicon wafer having a thermal oxide film formed on its surface, the concaves or convexes of the movable section driving electrode 52 are arranged at a pitch of about 64 μm.

The first movable section electrode 53 is composed of a plurality of projection-like stripes formed by etching; the stripes are extended in the moving direction of the first movable section 50 so as to lie opposite the electrode 43A as shown in FIG. 3D, and are arranged in parallel in the direction Y. Here, the first movable section 53 corresponds to a channel 7 (ch7).

The first movable section 60 comprises a substantially parallelepiped support 61 formed of a conductive material having a hollow portion as shown in FIGS. 1 and 2. The support 61 can be formed by, for example, physically grinding or chemically etching a conductive material. Alternatively, the support 61 may be formed by injecting a conductive resin. A movable section driving electrode 62 is formed on the top surface of the support 61. The second movable section electrode 63 is formed on the bottom surface of the support 61. Moreover, a lens 64 is fixed to the hollow portion.

As in the case of the first movable section 50, the support 61 comes into contact with the stator frame 41, the driving electrode substrate 42, and the holding electrode substrate 43. The film 70 is provided on a contacting surface of the support 61. As already described, the film 70 preferably contains, for example, a material containing any of deposited gold, molybdenum disulfide, a silicon oxide film, a silicon nitride film, and diamond like carbon. The following are similar to those for the first movable section 50: the method for depositing gold, molybdenum disulfide, a silicon oxide film, a silicon nitride film, or diamond like carbon and the addition of another substance. Accordingly, their description is omitted.

The movable driving electrode 62 is formed on the top surface of the second movable section 60 as shown in FIG. 4. The movable section driving electrode 62 is formed as a plurality of stripes composed of concaves and convexes arranged in parallel in the moving direction X. The stripes are formed, by etching, like projections extended orthogonally to the moving direction X of the second movable section 60. The spacing between the stripes is, for example, about 32 μm. The height of each convex portion is set at about 10 μm from the surface in each concave portion. The height may be at least 10 μm and may thus be larger than 10 μm. That is, the width of each convex of the movable section driving electrode 62 is equal to double the pitch of the driving electrodes 42A to 42D. The bottom surface of each concave of the movable section driving electrode 62 has a width equal to double the pitch of the driving electrodes 42A to 42D. If, for example, the driving electrode substrate 42 is a silicon wafer having a thermal oxide film formed on its surface, the concaves or convexes of the movable section driving electrode 62 are arranged at a pitch of about 64 μm.

The second movable section electrode 63 is composed of a plurality of projection-like stripes formed by etching; the stripes are extended in the moving direction of the first movable section 50 so as to lie opposite the electrode 43B, and are arranged in parallel in the direction Y. Here, the second movable section 63 corresponds to a channel 8 (ch8).

The electrodes shown in FIG. 4 are driven to change the above arrangement of the lens 54 in the first movable section 50 and the lens 64 in the second movable section 60. A lens system composed of these lenses is zoomed between a wide side and a tele side. The focus of the subject is adjusted on the basis of the focal distance determined by the zooming.

In the image pickup apparatus 10 configured as described above, the first and second movable sections 50 and 60 are driven as described below.

To drive the first movable section 50, a potential difference is applied to between the driving electrodes 42A to 42D and the movable section electrode 52 and to between the stripe electrode 43A and the first movable section electrode 53. Then, an electrostatic force is exerted between the driving electrodes 42A to 42D and the movable section electrode 52 and between the stripe electrode 43A and the first movable section electrode 53. The electrostatic force attracts these electrodes to one another. The first movable section 50 can be moved by switching the target of potential difference application between the driving electrodes 42A to 42D and the stripe electrode 43A, as disclosed in, for example, Jpn. Pat. Appln. KOKAI Publication No. 2004-126009 and the corresponding U.S. patent application Ser. No. 10/672,409, filed Sep. 29, 2003, Koga et al.

On the other hand, to drive the second movable section 60, a potential difference is applied to between the driving electrodes 42A to 42D and the movable section electrode 62 and to between the stripe electrode 43B and the second movable section electrode 63. Then, an electrostatic force is exerted between the driving electrodes 42A to 42D and the movable section electrode 62 and between the stripe electrode 43B and the second movable section electrode 63. The electrostatic force attracts these electrodes to one another. Like the first movable section 50, the second movable section 60 can be moved by switching the target of potential difference application between the driving electrodes 42A to 42D and the stripe electrode 43B.

To hold the first movable section 50, a potential difference is applied to between the stripe electrode 43A and the first movable section electrode 53. Then, an electrostatic force is exerted between the stripe electrode 43A and the first movable section electrode 53. The electrostatic force attracts these electrodes to each other, thus enabling the first movable section 50 to be held. To hold the second movable section 60, a potential difference is applied to between the stripe electrode 43B and the second movable section electrode 63.

In the image pickup apparatus 10 and zoom lens unit 30 configured as described above, the film 70 is provided on the surfaces of the supports 51 and 61 which come into contact with the stator frame 41, driving electrode substrate 42, and holding electrode substrate 43. Accordingly, only large coefficients of friction exist between the support 51 or 61 and the stator frame 41, between the support 51 or 61 and the driving electrode substrate 42, and between the support 51 or 61 and the holding electrode substrate 43. This makes it possible to allow the first and second movable sections 50 and 60 to maintain high moving speeds. The abrasive resistance of the supports 51 and 61 is also improved.

The increased moving speeds of the first and second movable sections 50 and 60 improve the focusing of the image pickup apparatus 10 and increase the speed of a zooming operation. This enables the image of the subject to be detected more quickly and clearly.

Further, since the film 70 is provided on the surfaces of the supports 51 and 61 which come into contact with the stator frame 41, driving electrode substrate 42, and holding electrode substrate 43, the selection of the material for the supports 51 and 61 is not limited. Even if the surfaces of the supports 51 and 61 have a small coefficient of friction, the film 70 can be used to reduce the coefficient of friction of the supports 51 and 61. This makes it possible to increase the number of choices of the materials for the supports 51 and 61, stator frame 41, driving electrode substrate 42, and holding electrode substrate 43. The materials can be varied depending on the purpose, specifications, or target lifetime of the image pickup apparatus 10. This enables an increase in the degree of freedom in design.

### Second Embodiment

FIG. 5 is a schematic perspective view schematically showing a first movable section 50B of an electrostatic actuator according to a second embodiment of the present invention. In FIG. 5, the same components as those in the first embodiment shown in FIG. 1 have the same reference numerals. Their description is thus omitted.

The zoom lens unit 30 comprises the first movable section 50B, shown in FIG. 5, in place of the first movable section 50, shown in FIGS. 1 and 2. The first and second movable sections 50B and 60 are inserted and arranged in the stator frame 41 so that they can move along the direction X of the optical axis while being separated from each other.

The first movable section 50B comprises a substantially parallelepiped support 51B formed of a conductive material having a hollow portion. The support 51B can be formed by, for example, physically grinding or chemically etching a conductive material as in the case of the first embodiment. Alternatively, the support 51B may be formed by injecting a conductive resin. A stopper 55 is provided at each of the opposite ends of the support 51B in the moving direction X. The stoppers 55 are formed like concaves because they come into contact with the stator frame 41, driving electrode substrate 42, and holding electrode substrate 43.

For example, a conductive PPS or a conductive PS resin may be used as the conductive resin of the support 51B, as in the case of the first embodiment. The conductive PPS resin is particularly preferably used as the material for the support 51B because of its electrical characteristics and moldability. Further, it is preferable to add a fluorine-based material (for example, PTEE), or potassium titanate, oil, or carbon fiber to the conductive PPS resin in order to reduce the coefficient of friction. It may be add any one of the fluorine-based material, potassium titanate, oil, and carbon fiber. However, it is also possible to add a plurality of additives, for example, PTFE and oil.

As in the case of the first embodiment, the film 70 (a protect film) is provided on the surfaces of the stoppers 55 which come into contact with the stator frame 41, driving electrode substrate 42, and holding electrode substrate 43. As in the case of the first embodiment, the film 70 preferably contains, for example, any of deposited gold, molybdenum disulfide, a silicon oxide film, a silicon nitride film, and diamond like carbon. With gold or molybdenum disulfide, the film 70 can be formed on the surface of the support 51 using the well-known sputtering or deposition method. With a silicon nitride film, a silicon nitride film, or diamond like carbon, the film 70 can be formed using the well-known sputtering method. Alternatively, the film 70 may be produced using the well-known deposition method such as electroplating or electroless plating.

Further, another appropriate substance may be added to gold, molybdenum disulfide, a silicon oxide film, a silicon nitride film, or diamond like carbon. For example, hardness or wear resistance can be improved by adding a substance such as nickel, silver, indium, or cobalt to gold. The material for the film 70 can be appropriately determined according to the materials for the support 51B, stator frame 41, driving electrode substrate 42, and holding electrode substrate 43, the use environment and specifications of the zoom lens unit 30, and the target lifetime.

In the image pickup apparatus 10 and zoom lens unit 30 configured as described above, the film 70 is provided on the surface of the support 51B on which the stoppers 55 come into contact with the stator frame 41, driving electrode substrate 42, and holding electrode substrate 43. This serves to maintain only small coefficients of friction between the stoppers 55 and the stator frame 41, driving electrode substrate 42, and holding electrode substrate 43. This makes it possible to allow the first movable section 50B to maintain a high moving speed. The abrasive resistance of the support 51B is also improved.

The increased moving speed of the first movable section 50B improves the focusing of the image pickup apparatus 10 and increases the speed of a zooming operation. This enables the image of the subject to be detected more quickly and clearly.

Further, since the film 70 is provided on the surfaces of the stoppers 55 which come into contact with the stator frame 41, driving electrode substrate 42, and holding electrode substrate 43, it is possible to reduce the coefficient of friction of the surface of the support 51B regardless of the material for the support 51B. This makes it possible to increase the number of choices of the materials for the support 51B, stator frame 41, driving electrode substrate 42, and holding electrode substrate 43. The materials can be varied depending on the purpose, specifications, or target lifetime of the image pickup apparatus 10. This enables an increase in the degree of freedom in design.

The provision of the stoppers 55 enables a further reduction in the coefficient of friction between the first movable section 50B and each of the stator frame 41, driving electrode substrate 42, and holding electrode substrate 43. Therefore, the moving speed of the first movable section 50B can be further increased.

The second movable section 60 may have the same configuration as that of the first movable section 50B. Thus, the description of the second movable section 60 is omitted.

### EXAMPLE 1

Experiments were made using the zoom lens unit 30, shown in FIG. 1. The first movable section 50 used in the experiments had the film 70 of thickness 2,000 angstrom formed on the surface of the support 51 by executing a sputtering process to deposit a silicon nitride film (Si₃N₄). The first movable section 50 was placed on the driving electrode substrate 42 so that the surface with the movable section driving electrode 52 faced downward. The driving electrode substrate 42 was then gradually tilted. Thus, the angle of the driving electrode substrate 42 was checked at which the first movable section 50 started to slide. The support 51 was formed by injecting a conductive PPS to which potassium titanate had been added.

Further, movable sections free from the film 70 were provided as comparative examples of conventional lens units. Similar experiments were carried out on the four zoom lens units described below.

### COMPARATIVE EXAMPLE 1

The support 51 was formed by injecting a conductive PPS to which PTFE had been added. No film was provided on the surface of the support 51. The other arrangements and the measuring method were equivalent to those used in Example 1.

### COMPARATIVE EXAMPLE 2

The support 51 was formed by injecting a conductive PPS to which potassium titanate had been added. No film was provided on the surface of the support 51. The other arrangements and the measuring method were equivalent to those used in Example 1.

### COMPARATIVE EXAMPLE 3

The support 51 was formed by injecting a conductive PPS to which carbon fiber had been added. No film was provided on the surface of the support 51. The other arrangements and the measuring method were equivalent to those used in Example 1.

### COMPARATIVE EXAMPLE 4

The support 51 was formed by injecting a conductive PPS to which oil had been added. No film was provided on the surface of the support 51. The other arrangements and the measuring method were equivalent to those used in Example 1.

As shown in Table 1, in Comparative Examples 1 to 4, the first movable section 50 started to slide when the driving electrode substrate 42 was inclined at an angle of 26 to 30°. On the other hand, in Example 1, the first movable section 50 started to slide when the driving electrode substrate 42 was inclined at an angle of at most 20°.

TABLE 1

Sliding Angle(°)

| | Sample A | Sample B |
|---|---|---|
| Comparative Example 1 | 27 | 26 |
| Comparative Example 2 | 26 | 27 |
| Comparative Example 3 | 29.5 | 29.5 |
| Comparative Example 4 | 28 | 29.5 |
| Example 1 | 19 | 19.5 |
| Example 2 | 20 | 20 |

Further, Example 1 and Comparative Example 2 were incorporated into the zoom unit 30 and compared in terms of the moving speed of the first movable section 50. The results of the comparison are shown in Table 2.

TABLE 2

| | Comparative | | |
|---|---|---|---|
| Moving Speed | Example 2 | Example 1 | Example 2 |
| 1 mm/sec | ∘ | ∘ | ∘ |
| 3 mm/sec | x | ∘ | ∘ |
| 6 mm/sec | x | ∘ | x |

As shown in Table 2, the first movable section 50 in Comparative Example 2 could not be moved at a moving speed of at least 3 mm/sec. On the other hand, the first movable section 50 in Example 1 could be moved at a moving speed of 6 mm/sec.

### EXAMPLE 2

Experiments were made using the zoom lens unit 30 according to the first embodiment, shown in FIG. 1. The first movable section 50 used in the experiments had a silicon oxide film (SiO₂) of thickness 1000 angstrom formed on the surface of the support 51 by sputtering. The first movable section 50 was placed on the driving electrode substrate 42 so that the surface with the movable section driving electrode 52 faced downward. The driving electrode substrate 42 was then gradually tilted. Thus, the angle of the driving electrode substrate 42 was checked at which the first movable section 50 started to slide. The support 51 was formed by injecting a conductive PPS to which potassium titanate had been added.

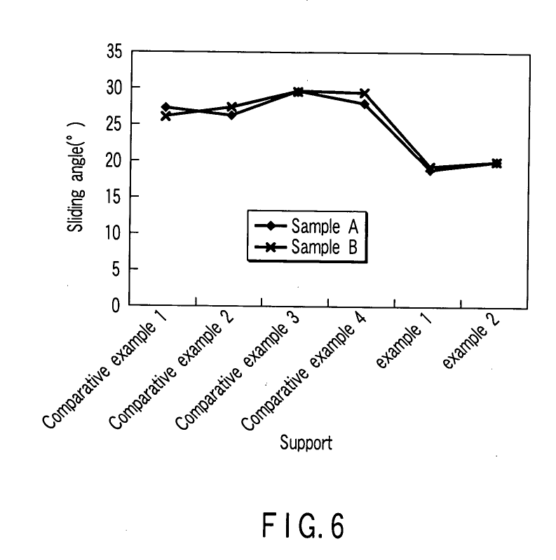

As shown in FIG. 6, in Comparative Examples 1 to 4, the first movable section 50 started to slide when the driving electrode substrate 42 was inclined at an angle of 26 to 30°. On the other hand, in Example 2, the first movable section 50 started to slide when the driving electrode substrate 42 was inclined at an angle of at most 20°.

Further, Example 2 and Comparative Example 2 were incorporated into the zoom unit 30 and compared in terms of the moving speed of the first movable section 50. The results of the comparison are shown in Table 1.

As shown in Table 1, the first movable section 50 in Comparative Example 2 could not be moved at a moving speed of at least 3 mm/sec. On the other hand, the first movable section 50 in Example 2 could be moved at a moving speed of 3 mm/sec.

As described above, the present invention can provide an electrostatic actuator and an image pickup apparatus in which movable sections can move at high speeds.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An electrostatic actuator comprising:
a stator;
a first and second substrates each provided opposite the stator;
a movable section provided in the stator and guided by the stator so as to be movable in a predetermined direction between the first and second substrates;
a holding electrode provided on the first substrate, configured to attract and hold the movable section;
a first insulating layer which covers the holding electrode;
driving electrodes, provided on the second substrate at a fixed pitch in the predetermined direction, which drive the movable section;
a second insulating layer which covers the driving electrodes; and
a protect film provided on a surface area of the movable section which contacts the first and second insulating layers as the movable section moves.

2. The electrostatic actuator according to claim 1, wherein the protect film contains any of deposited gold, molybdenum disulfide, and diamond like carbon.

3. The electrostatic actuator according to claim 1, wherein the protect film is a silicon oxide film or a silicon nitride film.

4. The electrostatic actuator according to claim 3, wherein each of the first and second insulating films is a silicon oxide film or a silicon nitride film.

5. The electrostatic actuator according to claim 1, comprising a member which maintains the stator and the movable section in a vacuum, air-tight state.

6. The electrostatic actuator according to claim 5, wherein the member is a glass plate.

7. An image pickup apparatus comprising:
a stator;
a first and second substrates each provided opposite the stator;
a movable section provided in the stator and guided by the stator so as to be movable in a predetermined direction between the first and second substrates;
a holding electrode provided on the first substrate, configured to attract and hold the movable section;
a first insulating layer which covers the holding electrode;
driving electrodes, provided on the second substrate at a fixed pitch in the predetermined direction, configured to drive the movable section;
a second insulating layer which covers the driving electrodes;
a protect film provided on a surface area of the movable section which contacts the first and second insulating layers as the movable section moves;
a lens provided in the movable section to form an image of a subject; and
an image pickup element which detects the image of the subject formed by the lens.

8. The image pickup apparatus according to claim 7, wherein the protect film contains any of deposited gold, molybdenum disulfide, and diamond like carbon.

9. The image pickup apparatus according to claim 7, wherein the protect film is a silicon oxide film or a silicon nitride film.

10. The image pickup apparatus according to claim 9, wherein each of the first and second insulating films is a silicon oxide film or a silicon nitride film.

11. The image pickup apparatus according to claim 7, comprising a member which maintains the stator and the movable section in a vacuum, air-tight state.

12. The image pickup apparatus according to claim 11, wherein the member is a glass plate.

13. An electrostatic actuator comprising:
a stator;
a first and second substrates each provided opposite the stator;
a movable section provided in the stator and guided by the stator so as to be movable in a predetermined direction between the first and second substrates;
a holding electrode provided on the first substrate to attract and hold the movable section;
a first insulating layer which covers the holding electrode;
driving electrodes, provided on the second substrate at a fixed pitch in the predetermined direction, configured to drive the movable section;
a second insulating layer which covers the driving electrodes; and
a housing which maintains the stator, the first and second substrates.
